(19) United States
(12) Patent Application Publication
(10) Pub. No.: US 2009/0132493 A1
(43) Pub. Date: May 21, 2009

(54) Method for retrieving and editing HTML documents

(76) Inventor: Scott Decker, Seattle, WA (US)

Correspondence Address: PROSKAUER ROSE LLP, ONE INTERNATIONAL PLACE, BOSTON, MA, 02110, US

(21) Appl. No.: 12/228,254

(22) Filed: Aug. 11, 2008

Related U.S. Application Data
(60) Provisional application No. 60/955,117, filed on Aug. 10, 2007.

(51) Int. Cl. G06F 7/06; G06F 17/30; G06F 17/00

(52) U.S. Cl. 707/3; 707/100; 715/234; 707/206; 707/E17.014; 707/E17.044; 707/E17.108

(57) ABSTRACT

A method and system for retrieving and displaying a HTML document. The method can include retrieving the HTML documents from a first source, formatting the HTML document, storing and mapping the HTML document in a database index, and displaying the HTML document. In addition, the method and system can include a query engine to find at least one additional HTML document related to the HTML document.

### CROSS REFERENCE TO RELATED APPLICATIONS

This application claims the benefit of U.S. Patent Application No. 60/955,117, which was filed on Aug. 10, 2007, titled “Method for Retrieving and Editing HTML Documents,” the entire contents of which are hereby incorporated herein by reference.

### BACKGROUND

HTML is the language typically used to write web pages. The HTML language specifies a fixed number of tags or containers that encapsulate content such as text and images. These tags tell the browser general information about the nature of the content, for example, if it is part of a paragraph, a table, or whether or not the text should be in bold, italics, etc. In addition, tags may contain attributes associated with that tag that tell the browser specific information about that tag. Some examples include, the display size, whether there should be a border, and how to align contained text. HTML documents may contain grammatical mistakes and still be displayed flawlessly by a web browser. In addition, an author of an HTML page may not specify where a tag ends, making it ambiguous as to whether a certain section of a document is part of a table, a paragraph, etc.

### SUMMARY

Webcrawlers and aggregators can be used to track a number of websites and retrieve HTML documents from those websites. This can be desirable since checking numerous website sources can be time consuming and difficult. In some cases, a feed or a channel can be used to regularly retrieve the information and aggregators can be used to present the retrieved information on to a single interface. As a result, aggregators can be used to provide articles or text relating to a subject of interest. A typical aggregator, such as an RSS reader, presents a list of hyperlinks along with relevant data to help a user determine whether the link should be followed to view the related article or text. Even though aggregators may present related text and/or metadata to provide context for the link, the related metadata or text provided might be poorly formatted or the user may have to follow the link to view the web pages' article or text in its entirety.

An aspect of this invention includes a method for retrieving and displaying a HTML document. The method can include retrieving the HTML documents from a first source, formatting the HTML document, storing and mapping the HTML document in a database index, and displaying the HTML document.

Another aspect of this invention includes a system for retrieving and displaying a HTML document. In some embodiments the system can include a retrieval module for retrieving HTML documents from a first source and a formatting module for formatting the retrieved HTML documents. In some embodiments the systems can also include an indexing module for storing and mapping the HTML documents in a database index, a query module for running a query engine to find related HTML documents, and a displaying module for displaying the HTML documents.

A further aspect of the invention includes a system for retrieving and displaying a HTML document that includes means for retrieving HTML documents from a first source. In some embodiments the systems includes means for formatting the retrieved HTML documents and means for indexing the formatted HTML documents. Some embodiments also include means for tagging and mapping the indexed HTML documents and means for displaying the tagged and mapped HTML documents on a website.

In other examples, any of the aspects above, or any apparatus or method described herein, can include one or more of the following features.

In some embodiments, a feature of the method of retrieving and displaying a HTML document can include running a query engine to find at least one additional HTML document related to the HTML document. Another feature of formatting the HTML document include editing the HTML document. In some embodiments the step of formatting the HTML document can also include parsing the HTML document. And some embodiments the step of formatting can include printing the HTML document.

A further feature of the invention includes calculating a ratio of a length of a tag to a length of regular text for each line in the HTML document, and removing the line if the ratio is less than a predetermined value.

A feature of the invention can also include retrieving the HTML document from a source mapped to a predetermined subject, and in come embodiments a further feature includes storing the HTML document in an index with at least one of a publication date, a subject, a title, the source, or an image associated with the HTML document.

Another feature of the invention includes storing the HTML document in a first index and removing duplicate HTML documents from the first index. In some embodiments the invention step of removing duplicate HTML documents from the first index can also include comparing titles of HTML documents.

In some embodiments, a feature of the invention also includes tagging the HTML document in the first index related to a predetermined subject. And in some embodiments, a feature can include updating the first index with an additional HTML document from a second index and in some embodiments mapping the HTML document in the first index related to the predetermined subject of the HTML document.

A further feature of the invention includes updating the second index with the tagged HTML documents and the mapped HTML documents.

### BRIEF DESCRIPTION OF THE DRAWINGS

The foregoing and other objects, features and advantages, will be more fully understood from the following illustrative description, when read together with the accompanying drawings, which are not necessarily to scale.

FIG. 1 is a schematic depicting an overall architecture of the system, according to one embodiment;

FIG. 2 is a flow diagram depicting the process for retrieving, formatting, and displaying an HTML document, according to one embodiment; and

FIGS. 3A and 3B show screen shots of a website according to one embodiment displaying an article from another websites.

### DETAILED DESCRIPTION

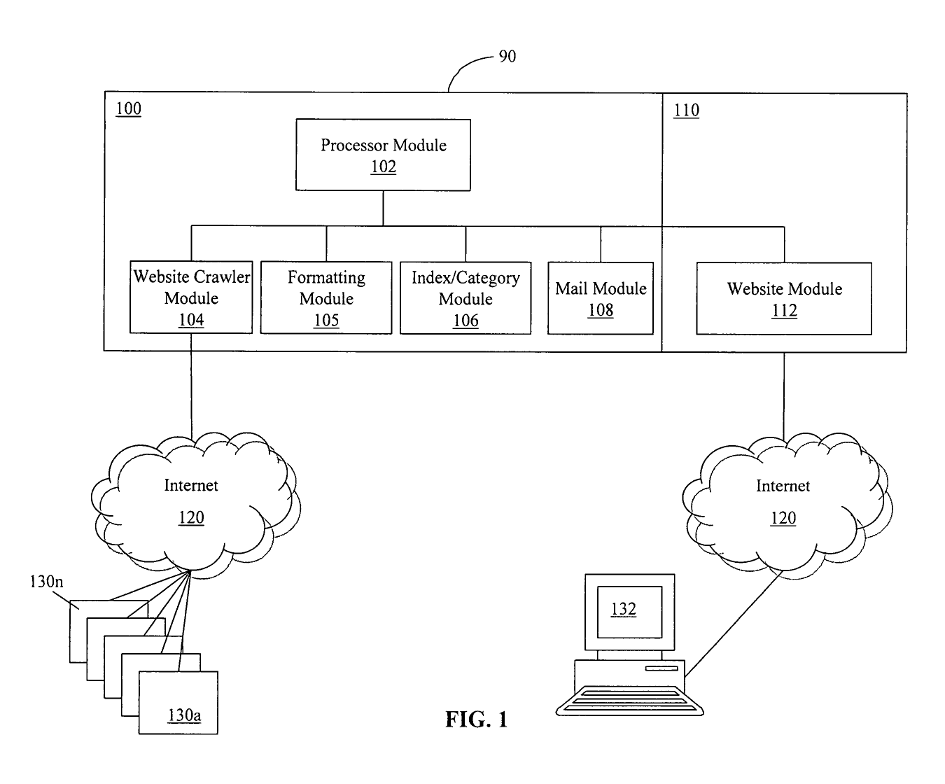

FIG. 1 shows a system 90 for retrieving, formatting, indexing/categorizing, and displaying web content to a user. The system 90 includes a backend module 100 and a front end module 110. The backend module 100 includes a processor 102, a website crawler module 104, a formatting module 105, an index/categorizing module 106, and a mail module 108. The front end module 110 includes a website module 112. The website crawler module 104 retrieves data via the Internet 120 from a plurality of websites 130a . . . 130n. Under control of the processor 102, data retrieved by the website crawler 104 formatted by the formatting module 105 and then indexed and categorized by the index/categorizing module 106. The indexed and categorized data is provided to the website module 112 of the front end 110 to enable a user can to access/view the information on a remote terminal 132 via the Internet 120. In some instances, the user can setup a personal account on the system 90 though the website module. One advantage of setting up a personal account is to enable the user to instruct the system 90 email personalized data to the user via the mail module 108.

In some embodiments, a plurality of source websites can be researched and tagged as being related to a predetermined subject. For example, several source websites can be researched and tagged as being a source for articles, text, or information relating to a specific sports team, college, or an overall sport. Other examples can include subjects such as politics, medicine, news, celebrities, etc. Such tagging can be a “top level tagging process.” Data such as articles or text can be retrieved from these tagged source websites. In some embodiments, the data is retrieved every hour to update the information relating to predetermined subject matter. A parsing algorithm can be used to filter the content of the data. For example, an HTML text or article document can be parsed to limit the text to the core textual contents of the article. In some embodiments, the ads, menus, and extra text from the web page HTML document are removed so that the article can be displayed with such ads, menus or extra text. The data retrieved from the source websites and parsed/filtered can be stored in a queue to be refined by another process.

An indexing/categorizing module 108 places data in a working index to be indexed and categorized. In some embodiments, the working index is a database index. In some embodiments, the data can be taken at a predetermined interval (such as every hour) and copied into a work area. An algorithm can be used to remove texts or articles duplicative of other texts and/or articles. In some embodiments, certain articles and/or data are tagged as being related to a specific subject, such as a particular team, player or sport. If the articles and/or data are not tagged, queries can be made to determine which articles or data relates to a specific subject. In some embodiments, the queries are formulated to determine when the text of an article is predominately focused on the specific subject. Related articles and/or data taken from the various web pages or sources can be indexed by being mapped and grouped with one another.

The website module 112, according one embodiment, can have two sub-systems including a website running index and a website cache. The website module 112 can run off the website running index for all its articles and can provide the required coding for data display. When the indexing process is done, the website module 112 updates the website running index. The website module 112 can cache the website running index in the background through the website cache and swap the cache for the website module 112 thereby allowing the website module 112 to operate without any “downtime”.

In some embodiments, users of the website can create an account and setup a daily email service. The mail module 108 can use a script to check the website database to determine the users who need to have an email sent. The mail system module 108 can access the website module 112 for the user's account and send to the user updated data such as articles and/or text.

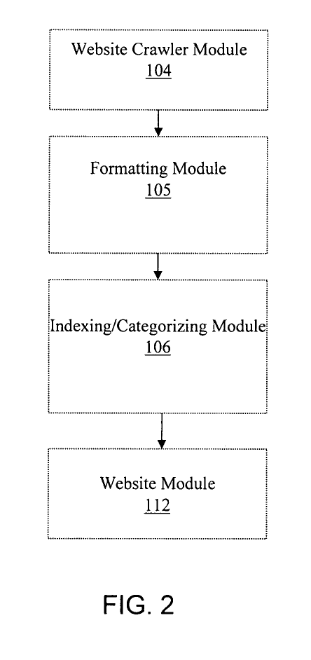

FIG. 2 represents a flow diagram depicting the process for retrieving and formatting an HTML document through the above described system 90 (FIG. 1). The website crawler module 104 retrieves data from at least one source. In some embodiments, the website crawler module 104 retrieves an HTML document from an external web source from the Internet 104 (FIG. 1). The formatting module 105 can format the HTML document to limit the text of the HTML to the “core text” of the article. After the formatting module 105 formats the HTML document, the indexing/categorizing module 106 adds the HTML document to a working index so that the article/text can be mapped and categorized.

The website crawler module 104 can retrieve data such as an HTML document from an external source website. In some embodiments, a plurality of sources are mapped to predetermined subjects, such source websites that focus on specific sports, teams or a colleges. Sources can be mapped to a predetermined subject if it is known that a source predictably provides articles or text on the subject. For example, if it is known that a specific source website always talks about a specific sports team, it may not be necessary to perform algorithms to ascertain the subject matter of the article.

After the website crawler module 104 retrieves an HTML document, the formatting module 105 formats the HTML document. In some embodiments, the formatting module 105 formats the HTML document to remove menus, ads, and other extra text that is not related to the subject matter of the article text itself. In the case of an HTML document, an algorithm can be used to balance the HTML and remove common HTML from the document. In some embodiments, script tags, style tags, “br” tags, “hr” tags, “param” tags, “embed” tags, object tags and “&rsquo” tags are removed from the HTML document. In some embodiments, colons (:) from the document are replaced with an “_x” because using colons in HTML documents can present problems when an HTML parser is used. An HTML parser can then be used to balance all the tags in the documents, so that each tag in the HTML document has both a start and a stop. In some embodiments, HTML comments are removed from the document.

The formatting module 105 can also run the HTML document through a printer, such as a prettyprinter that presents the document in such a way that is more easily readable to the user. In some embodiments, the prettyprinter can use a specific algorithm to reformat the text of the document. For example, the printer can place a new line after a “td” tag, “div” tag, “ul” tag, or “p” tag. Shorten on-click events can be used for “a href” tags up to a predetermined number of characters, such as 40 characters. In some embodiments, once a tag has been captured, if the tag is a “b” tag, “ahref” tag, “em” tag, “I” tag, “font” tag, “span” tag, “img” tag, or strong tag, no line is added but lines are added after the other tags. Bullets, “&bull”, “&nsbp”, and “\\n” items can be replaced with a space.

After the formatting module 105 runs the HTML document is run through the printer, the document can be reformatted to limit the text of the document to the “core text” of the document. Limiting the document to the core text of the document can mean limiting the document to the article itself or limiting the document to the text of the document that discusses the specific subject of the article. In some embodiments, lines of text that do not make up the core text of the articles are removed. Certain lines of text can be ignored and remain in the document. In some embodiments, lines with text comprising the words “Copyright”, “Terms of Service”, “Place your ad”, “Trackback”, “Sidebar”, or “Author” are kept in the document. In some embodiments, if a line starts with “Comments”, it may be desirable to wait to find the ending tag because the “Comments” have nothing to do with the core text of the article. Including “Comments” makes it difficult to find related articles, since those other articles do not have the same “Comments.” To determine which lines of text should be removed from the document, the printed HTML document can be taken and a ratio of the HTML tag length to the regular text length can be calculated for each line. If the ratio of the HTML to regular text is less than a predetermined value, then it can be assumed that the line is a text line, and it should remain in the document. In some embodiments, the ratio can be about 0.375. Once all the lines are reviewed and a determination is made as to whether the line should be removed or kept based on the calculated ratio or the text of the line itself, all the lines are gathered and stored as the “core text” of the article.

The indexing/categorizing module 106 can store the HTML document in a working index. In some embodiments, the categorizing/indexing module 106 stores articles with associated data such as a publication date, images associated with the article, and whether the document came from a local, national or video source. If it can be determined that the article is related to a specific subject, such as a specific team, sport, or college, the article can be mapped in the working index.

The indexing/categorizing module 106 adds the HTML document to a working index of HTML documents including articles from different web sources relating different subject matter. The indexing/categorizing module 106 filters the working index to remove duplicates and categorized HTML documents to organize the documents relating to a specific subject or topic. After the indexing/categorizing module 106 de-duplicates and categorizes the HTML documents in the working index, the website module 112 updates the website running index and website cache.

Once the indexing/categorizing module 106 adds an article to the working index of HTML documents, the working index can be de-duplicated. In some embodiments, the de-duplication process involves finding a title of an article and searching for any titles that are within one word of an exact match of the similar terms. By way of example, if an article has the title “Cowboys take the Super Bowl” a query of similar terms can bring up matches such as “Super Bowl taken by Cowboys” or “Cowboys take the Bowl.” In some embodiments, if the word count of the title is longer than 5 words, a percentage closeness match can be done. Given the length of the title, titles with the same words are found, but the length can be a predetermined percentage, such as 80%, for there to be a match. If there is a match, then it can be assumed that it is likely a duplicate title and/or article. In some embodiments, duplicate articles found by using such an algorithm are removed from the working index.

The working database index of HTML documents can contain a plurality of articles and text that relate to varying subject matter. The indexing/categorizing module 106 can group or map the HTML documents according to the subject matter of the article. In some embodiments, algorithms can be used to find and categorize articles or text relating to a specific subject, such as a sports team or player. The level of detail required for a query can depend on the level of specificity of the mapped subject matter of an article. If an article is grouped by a specific subject matter, then a less focused query can be used. If an article is grouped by a broad topic, however, a focused query can be used. For example, if an article is already mapped to a specific subject, such as a team or a player, the article is more likely to be displayed for that specific subject. If the article's source has been pre-mapped with a specific group of tags, it is more likely to then be displayed for that tag grouping. It article's source needs to match certain queries, but those queries are much more loose, because the source mapping is trusted.

If an article is mapped to a focused but nonspecific subject, the query can be loosened. For example, if an article is mapped to a team and an article needs to be found regarding a specific player on the team, a loosened query can be used based upon the last name of the player. If the last name of the player is found in an article mapped to the team, then it is likely an article about that player. In some embodiments, the full name of the player may be searched to confirm the relevancy of the article.

If an article is mapped to a less specific subject, then a more detailed query can be run. For example, if an article is only mapped to a college, the query should not have keywords relating to any sports other than the specific sport that the user is interested in. This can be done to prevent retrieving articles that talk about unrelated sports teams from that college. In some embodiments, additional search terms are used to focus the query. For example, it can be a requirement that the name of one of the players from the college appear in the article.

If the article is mapped to a broad umbrella topic, then a strict, detailed query can be run. For example, if an article is mapped to a general sport, then the query must be appropriately fashioned. In the case of national sports teams, no national teams have duplicate names. Therefore, if an article is mapped to a national sport, if the name is mentioned in the title, it can likely be assumed that the subject matter of the article relates to that team. An example of a strict query includes ensuring that team names are in the articles or titles along with specific player queries.

Once all of the articles in the working index have been tagged, the indexing/categorizing module 106 can use an algorithm can be used to map articles related to one another. In some embodiments, articles and data retrieved over a predetermined interval can be combined into the working index. For example, articles and data retrieved in the past three (3) days can be taken from the website's running index and combined with the articles retrieved from the web sources. If data is retrieved hourly from external web sources, this can provide three (3) days and one (1) hour worth of content. With the articles combined from the working index and the website's running index, a query can be run to find related articles. In some embodiments, parameters such as the host of the web source and comparisons of the text can be used to perform the query. In some embodiments, the text of the articles must match up to a predetermined threshold percentage for it to be tagged as a related article. For example, if an article is from the same host, then the text of the articles must be highly similar to match the criteria. If the text of the articles match up to approximately 80%, then the articles can be tagged as being related to one another.

Once the indexing/categorizing module 106 tags and maps the HTML document in the working index, the website module 112 can update the website running index. The website module 112 adds the tagged working indexes to the website running index. In some embodiments, new additions are added to the working index, as well as mapping ones that had been mapped before. In one embodiment, the searcher/index process is run on an hourly basis. In the previous hour, articles are found that are related with each other. In the next hour, an article may be found that is related to just one of the previously found article's. Next, the article that is related is used to find all of it's related articles and all of these article's should also be related to this new article we just found. The website module 112 can also add the items that are related to the other articles to the working index. After the indexes have been updated, the website module 112 commands the website to load the updated working index in the background. Once the updated working index is uploaded, the website module 112 switches the caches to point to the updated website running index.

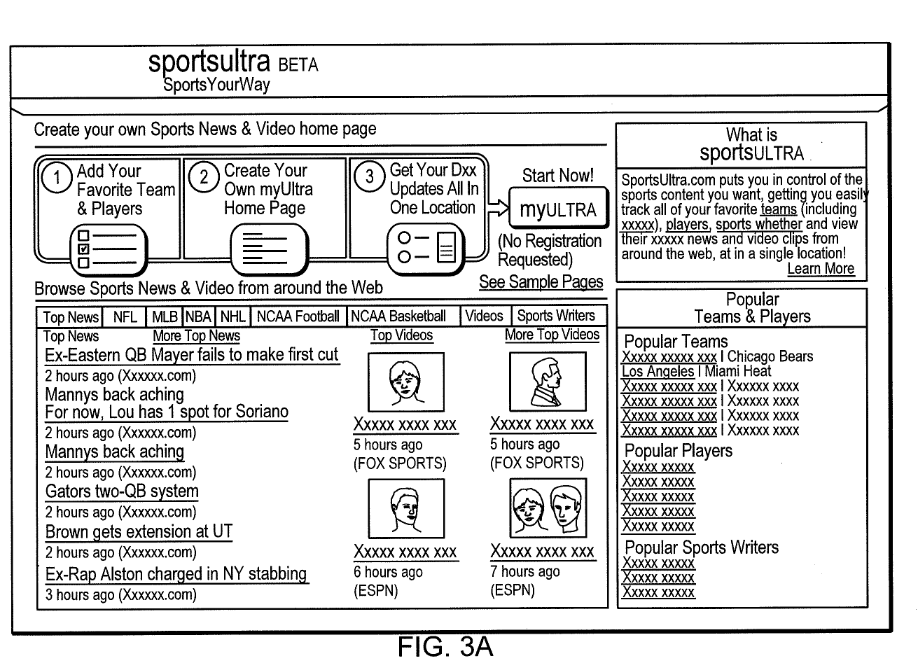

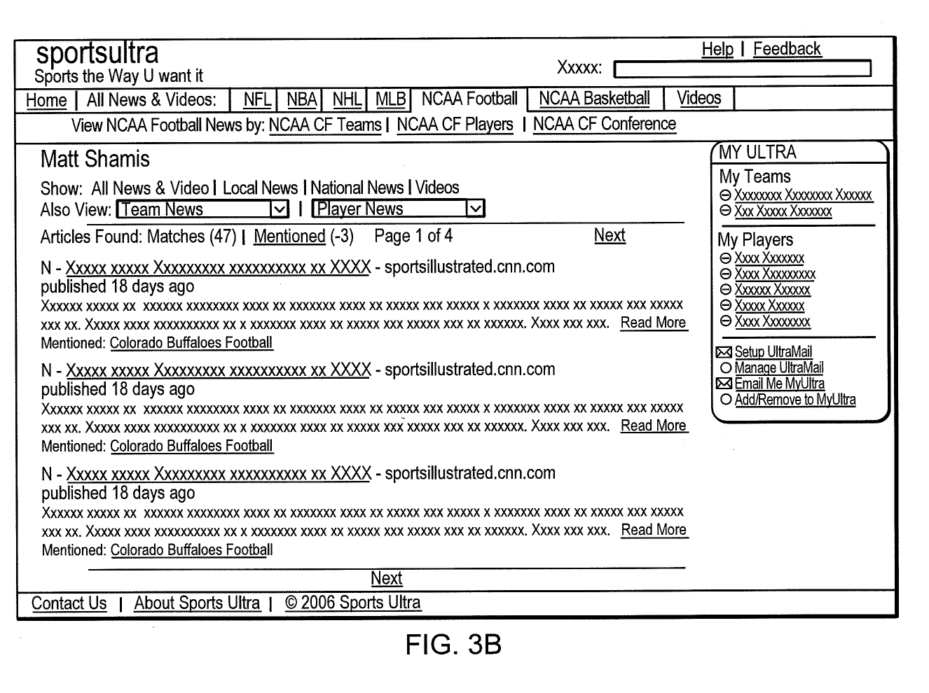

FIGS. 3A and 3B are screenshots of the website, according to one embodiment. As can be seen in FIG. 3A, the website allows a user to create pages to receive news and updates relating to their preferred sports teams, players, etc. The sports teams or players that the user chooses can be used as a predetermined subject to retrieve and locate related articles and information in the website running index. As discussed above in FIGS. 1-2, these articles can be retrieved from external source websites, reformatted, mapped and categorized to be displayed using the website as shown in FIG. 3A.

FIG. 3B shows how a user can go on to the website and pick a player to retrieve relevant articles and information about that player. As can be seen, the website provides a link to the external source website that published the article. The website can also provide the user with the “core text” of the article.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for retrieving and displaying a HTML document, comprising:
retrieving the HTML document from a first source;
formatting the HTML document;
storing and mapping the HTML document in a database index; and
displaying the HTML document.

2. The method of claim 1, further comprising running a query engine to find at least one additional HTML document related to the HTML document.

3. The method of claim 1, wherein the step of formatting the HTML document includes editing the HTML document.

4. The method of claim 1, wherein the step of formatting the HTML document includes parsing the HTML document.

5. The method of claim 1, wherein the step of formatting the HTML document includes printing the HTML document.

6. The method of claim 1, wherein the step of formatting the HTML document includes calculating a ratio of a length of a tag to a length of regular text for each line in the HTML document, and removing the line if the ratio is less than a predetermined value.

7. The method of claim 1, wherein the step of retrieving the HTML document includes retrieving the HTML document from a source mapped to a predetermined subject.

8. The method of claim 1 wherein the step of storing the HTML document includes storing the HTML document in an index with at least one of a publication date, a subject, a title, the source, or an image associated with the HTML document.

9. The method of claim 8, wherein the step of storing the HTML document includes storing the HTML document in a first index and removing duplicate HTML documents from the first index.

10. The method of claim 9, further comprising tagging the HTML document in the first index related to a predetermined subject.

11. The method of claim 10, further comprising updating the first index with an additional HTML document from a second index.

12. The method of claim 11, further comprising mapping the HTML document in the first index related to the predetermined subject of the HTML document.

13. The method of claim 12, further comprising updating the second index with the tagged HTML documents and the mapped HTML documents.

14. The method of claim 9, wherein the step of removing duplicate HTML documents from the first index comprises comparing titles of HTML documents.

15. A system for retrieving and displaying a HTML document, comprising:
a retrieval module for retrieving HTML documents from a first source;
a formatting module for formatting the retrieved HTML documents;
an indexing module for storing and mapping the HTML documents in a database index;
a query module for running a query engine to find related HTML documents; and
a displaying module for displaying the HTML documents.

16. A system for retrieving and displaying a HTML document, comprising:
means for retrieving HTML documents from a first source;
means for formatting the retrieved HTML documents;
means for indexing the formatted HTML documents;
means for tagging and mapping the indexed HTML documents; and
means for displaying the tagged and mapped HTML documents on a website.
